(19) United States
(12) Patent Application Publication
(10) Pub. No.: US 2005/0221859 A1
(43) Pub. Date: Oct. 6, 2005

(54) Electronic system and device utilizing the same

(75) Inventors: Chun-Hsiung Wang, Taipei Hsien (TW); Jui-Hsiang Chang, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Wistron NeWeb Corp.

(21) Appl. No.: 11/030,408

(22) Filed: Jan. 6, 2005

(30) Foreign Application Priority Data
Apr. 2, 2004 (TW) 93109213

(51) Int. Cl. H04M 1/00

(52) U.S. Cl. 455/557; 455/575.1

(57) ABSTRACT

An electronic system and device utilizing the same. The external device type is determined and provided corresponding function according to electrical parameter of the external device.

### BACKGROUND

The invention relates to an electronic system, and more particularly to an electronic system detecting different connected accessory types.

Conventional electronic systems, such as mobile communication or hand-held electronic devices, provide dedicated connection ports for various accessories. Mobile phone 100 in FIG. 1A provides a handsfree headset connector 102, data transmission connector 104, and charge connector 106. FIG. 1B is a schematic diagram of a handsfree headset, comprising earpiece and microphone attached to handsfree headset connector 102.

A data transmission device 120, as shown in FIG. 1C, connects via the data transmission connector 104 on the mobile phone 100.

A charge device 130, as shown in FIG. 1D connects via charge connector 106 on the mobile phone 100.

Dedicated connection ports for each of these and other accessories take up considerable space on the mobile phone 100 and increase production costs.

### SUMMARY

Embodiments of the invention provide an electronic system comprising a connecting port, a detecting device, and a processing device. The connecting port accepts an external device, the detecting device detects an electrical parameter of the external device when connected and the processing device determines the external device type and provides corresponding function according to the electrical parameter.

Also provided is a device accepting connection of an external device comprising a first connecting port, a main unit, a cable therebetween. The mobile phone comprises a second connecting port, a detecting device, and a processing device. The second connecting port can be coupled to the first connecting port. The detecting device detects an impedance of the cable and outputs an electrical parameter when the first connecting port is coupled to the second connecting port. The processing device determines the cable type and provides corresponding function according to the electrical parameter.

### BRIEF DESCRIPTION OF THE DRAWINGS

The invention can be more fully understood by reading the subsequent detailed description and examples with reference made to the accompanying drawings, wherein:

FIG. 1A shows a conventional mobile phone;

FIG. 1B shows a conventional handsfree headset;

FIG. 1C shows a conventional data transmission device;

FIG. 1D shows a conventional charge device;

FIG. 2 is a schematic diagram of a mobile phone according to embodiments of the invention;

FIG. 3A shows a handsfree headset according to embodiments of the invention;

FIG. 3B is an equivalent diagram of the handsfree headset according to embodiments of the invention;

FIG. 4A shows a data transmission device according to embodiments of the invention;

FIG. 4B is an equivalent diagram of the data transmission device according to embodiments of the invention;

FIG. 5A shows a charge device according to embodiments of the invention;

FIG. 5B is an equivalent diagram of the charge device according to embodiments of the invention;

FIG. 6 is a block diagram of an electronic system according to embodiments of the invention;

FIG. 7 is a circuit diagram according to embodiments of the invention;

FIG. 8A shows a theft prevention device according to embodiments of the invention;

FIG. 8B is an equivalent diagram of the theft prevention device according to embodiments of the invention.

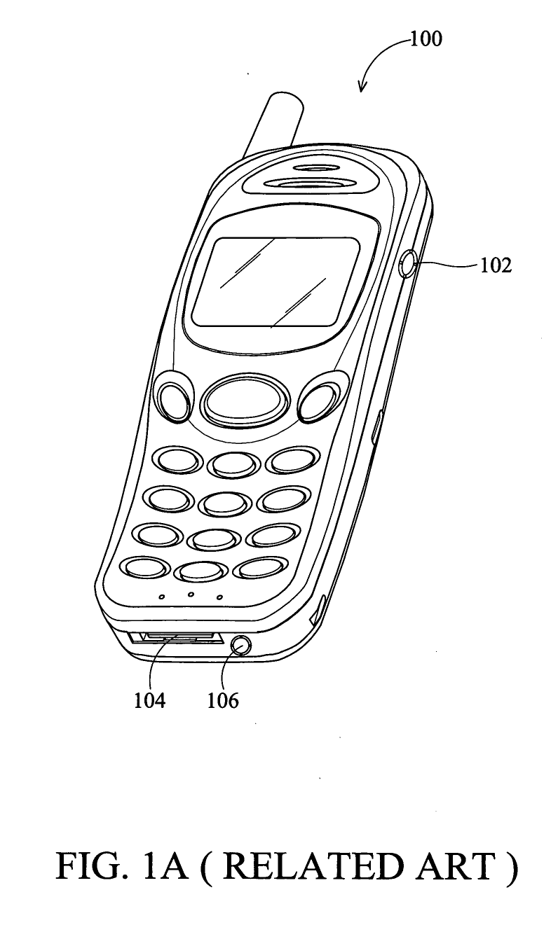

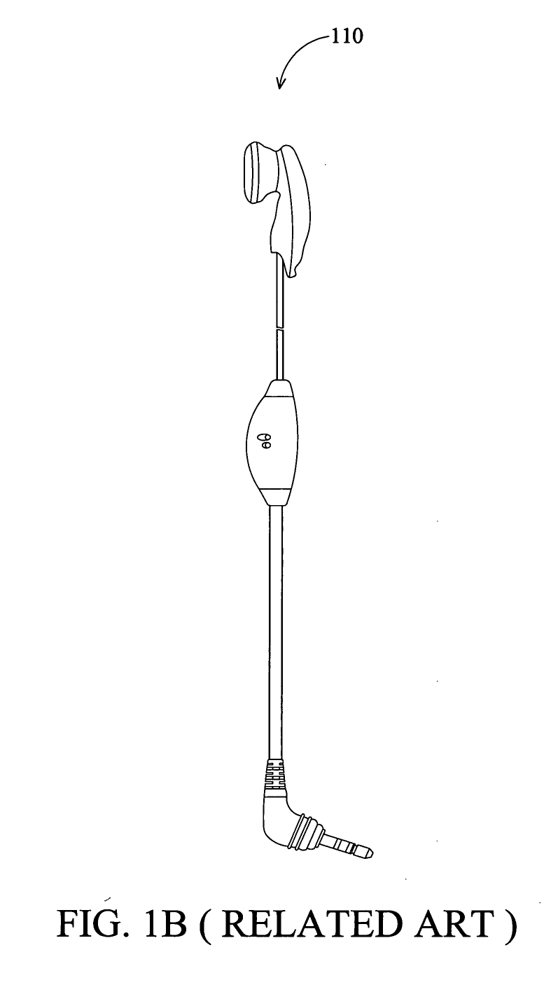

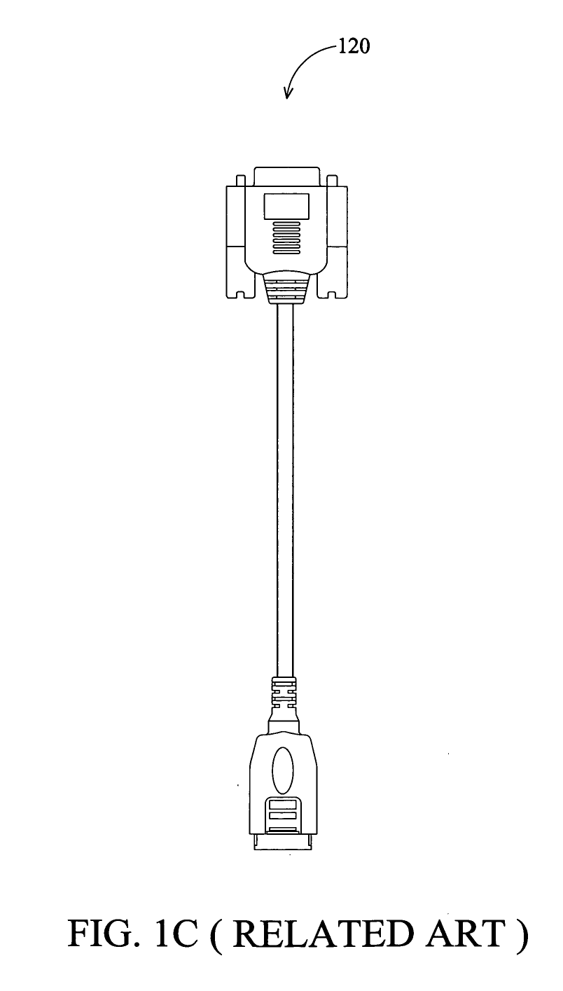

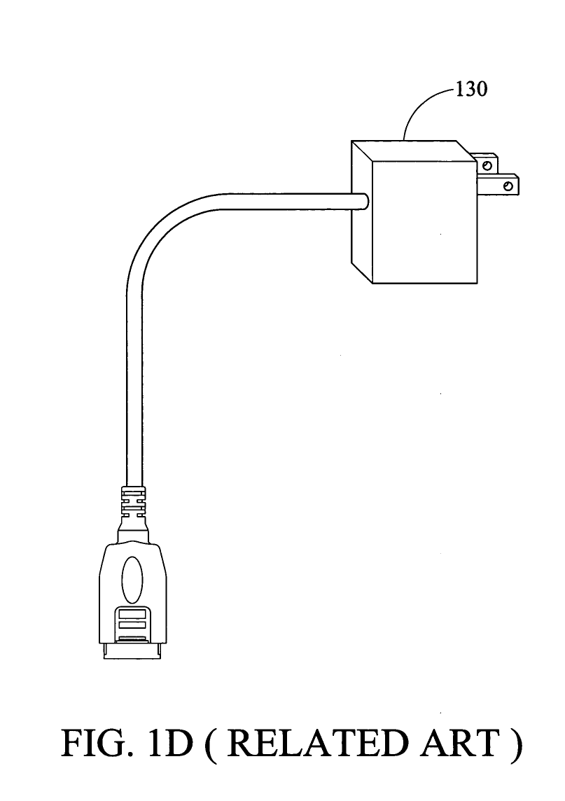

### DETAILED DESCRIPTION

An electronic system according to embodiments of the invention comprises a connecting port for multiple types of external devices.

When an external device is connected to the connecting port of the electronic system, the electronic system determines the external device's type according to an electrical parameter thereof. Typically, a connecting port utilizes a plug-into method or a contact method to connect the external device. For example, a mobile phone utilizes the contact method to connect a desk-top battery charger. Taking a mobile phone utilizing the plug-into method as an example, the principle of operation of the mobile phone is described in the following.

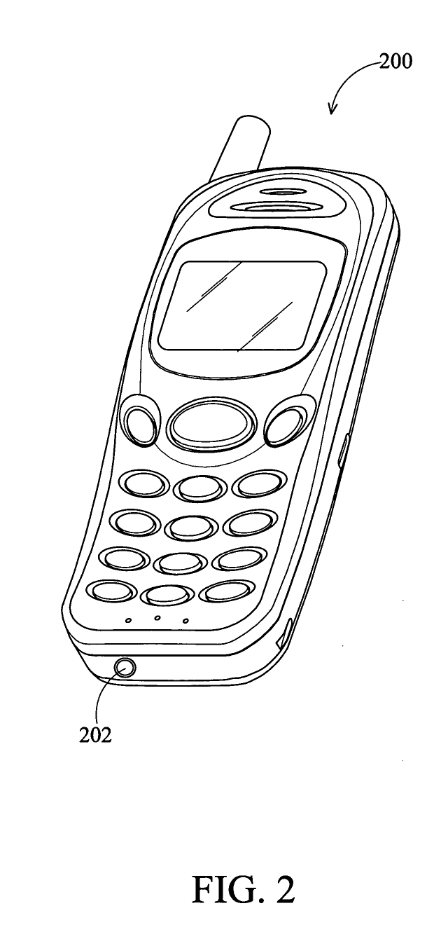

FIG. 2 is a schematic diagram of a mobile phone according to embodiments of the invention, comprising a single phone jack 202. To mate with the phone jack 202, external devices of the invention must have a corresponding phone plug for the phone jack 202.

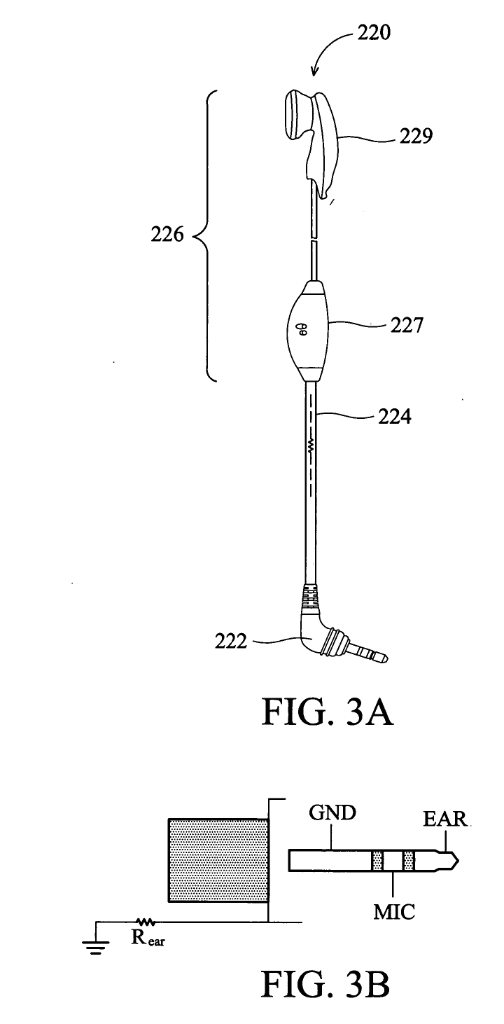

FIG. 3A shows a handsfree headset according to embodiments of the invention, comprising a phone plug 222, cable 224, and main unit 226 further comprising a microphone 227 and earphone 229. FIG. 3B is an equivalent diagram of the handsfree headset of FIG. 3A. A first terminal GND of the phone plug 222 couples to ground, a second terminal EAR transmits a signal to the earphone 229, and a third terminal MIC transmits a signal provided by the microphone 227. Impedance Rₑₐᵣ is an equivalent impedance of the cable 224.

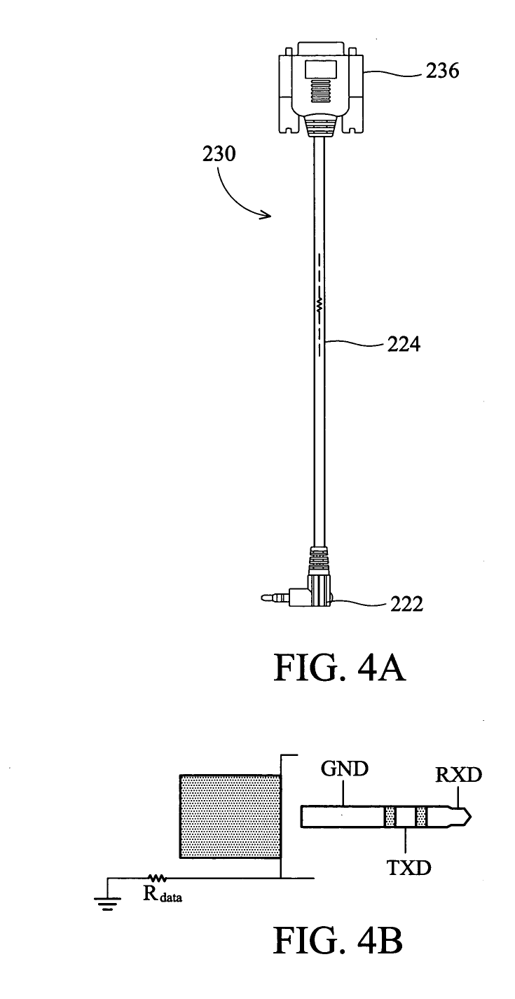

FIG. 4A shows a data transmission device according to embodiments of the invention, comprising a phone plug 222, a cable 234, and a main unit 236 such as a RS232 or USB interface, here a RS232 interface. FIG. 4B is an equivalent diagram of the data transmission device of 4A. A first terminal GND of the phone plug 222 couples to ground, a second terminal TxD receives data for the main unit 236. A third terminal RxD transmits the data. Impedance R_{data} is an equivalent impedance of the cable 234.

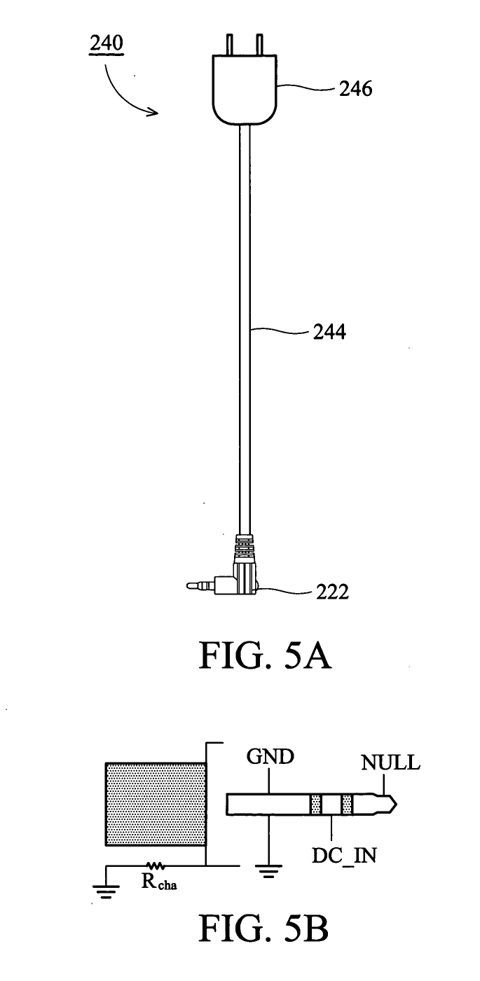

FIG. 5A shows a charge device according to embodiments of the invention, comprising a phone plug 222, a cable 244, and a main unit 246. FIG. 5B is an equivalent diagram of the charge device of 5A. A first terminal GND of the phone plug 222 couples to ground, a second terminal DC_IN provides a power signal. A third terminal NULL is not used. Impedance R_{cha} is an equivalent impedance of the cable 244.

As described, each external device comprises a corresponding cable and a corresponding main unit, one of which provides an electrical parameter, with the electronic system determining the external device type accordingly. Possible electrical parameter includes, but is not limited to, impedance, voltage, or current. In this embodiment, the electronic system determines the external device type according to the impedance of the cable.

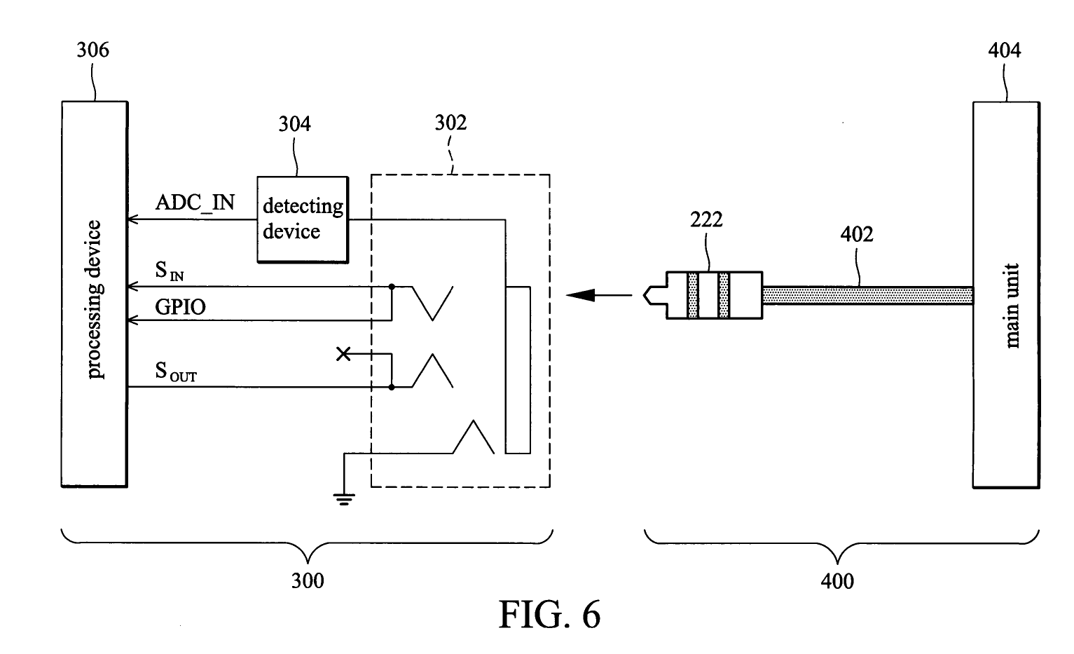

FIG. 6 is a block diagram of an electronic system 300 according to embodiments of the invention, comprising a connecting port 302, a detecting device 304, and a processing device 306. When an external device 400 is connected to the connecting port 302, a signal GPIO is output to the processing device 306. The detecting device 304 detects an electrical parameter ADC_IN of the external device 400 and processing device 306 determines the external device type accordingly, receiving an input signal S_{IN} or providing an output signal S_{OUT} as required.

As shown in FIG. 6, the external device 400 comprises a cable 402, a main unit 404, and a phone plug 222 between the main unit 404 and the phone plug 222. The impedance of main unit 404 of external device 400 differs from that of the cable 402, with the electrical parameter ADC_IN of the main unit 404 differing from that of the cable 402 accordingly.

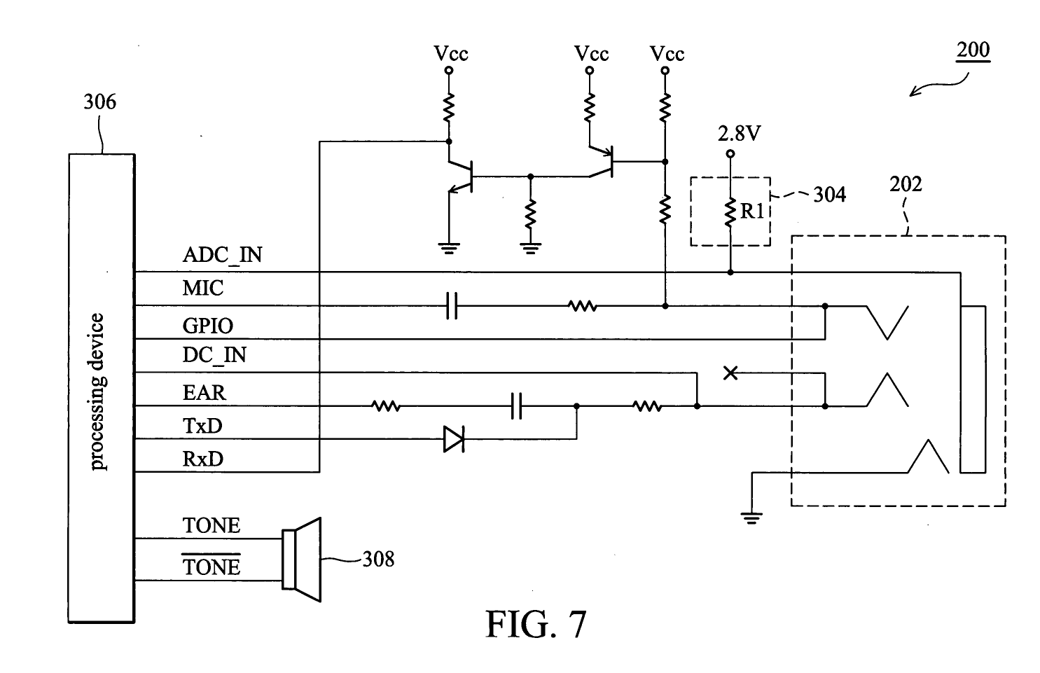

FIG. 7 is a circuit diagram according to embodiments of the invention. When phone plug 222 of the hands-free headset 220 shown in FIG. 3A connects to the phone jack 202, a notice signal GPIO is output to the processing device 306. The detecting device 304 detects the impedance of the cable 224. Upon receipt of the signal, the processing device 306 determines the external device type according to the detected electrical parameter ADC_IN.

Detecting device 304 here comprises a resistor R1, but is not limited thereto. The resistor R1 and the cable 224 connected in series, form a potential divider. The electrical parameter ADC_IN is detected via a voltage signal output therefrom. External device type can be detected by different detecting devices, such as a current detecting device detecting current into the external device. The processing device determines the external device type accordingly.

If the impedance of the resistor R1 is around 100 K ohm and the equivalent impedance Rₑₐᵣ of the cable around 39 K ohm, the electrical parameter ADC_IN is around 0.73 Volt-0.84 Volt. Upon receipt of the electrical parameter ADC_IN the processing device 302 enables handsfree headset function, receiving a signal MIC from the microphone 227 and outputting signal EAR to the earphone 229.

When the data transmission device in FIG. 4A connects the phone jack 202, if the equivalent impedance R_{data} of the cable 234 is around 100 K ohm, the electrical parameter ADC_IN is around 1.33 Volt˜1.47 Volt. Upon receipt of the electrical parameter ADC_IN, the processing device 302 enables data transmission function, receiving the data RxD and outputting the data TxD.

When the charge device in FIG. 5A connects to the phone jack 202, if the equivalent impedance R_{cha} of the cable 234 is around 0 ohm, the electrical parameter ADC_IN is around 0Volt. Upon receipt of the electrical parameter ADC_IN, the processing device 302 enables charge function, receiving the power signal DC_IN.

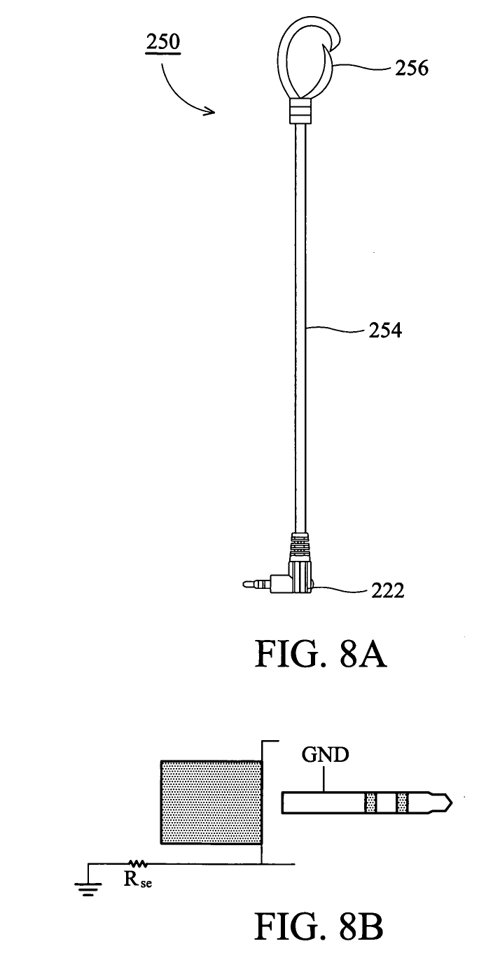

Additionally, the mobile phone of the invention provides theft prevention function when a theft prevention device is inserted into the mobile phone. FIG. 8A shows a theft prevention device of the invention, comprising a phone plug 222, a cable 254, and a main unit 256. The main unit 256 can be a clasp connecting to the user or other item, such as a handbag. FIG. 8B is an equivalent diagram of the theft prevention device 250 of FIG. BA. Impedance R_{sec} is an equivalent impedance of the cable 254.

When the theft prevention device 250 in FIG. 8A connects to the phone jack 202, the detecting device 304 detects the equivalent impedance R_{sec} of the cable 254. The processing device 306 activates theft prevention function accordingly, monitoring the connection between the theft prevention device and the phone jack 202. When the theft prevention device 250 is unexpectedly disconnected from the phone jack 202, the processing device 306 generates warning signals TONE and #TONE, output to a speaker 308, generating an alarm.

Additionally, in FIG. 7, many protection elements, such as resistors, capacitors, and transistors are added for maintaining performance of the invention. Since the operations of these elements are well known to those skilled in the field, these elements are not detailed description.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electronic system comprising:
a connecting port connecting with an external device;
a detecting device detecting an electrical parameter of the external device when the external device is coupled to the connecting port; and
a processing device, depending on the electrical parameter, determining the type of the external device and providing corresponding function accordingly.

2. The electronic system as claimed in claim 1, wherein the electrical parameter is generated by a cable of the external device.

3. The electronic system as claimed in claim 2, wherein the detecting device comprises a resistor, connected in series with the cable to create a potential divider, and the electrical parameter is detected via voltage output from the potential divider.

4. The electronic system as claimed in claim 1, wherein the processing device receives a signal output from the connecting port and determines the external device type when the external device connects to the connecting port.

5. The electronic system as claimed in claim 1, wherein the external device either inserts into or contacts with the connecting port.

6. The electronic system as claimed in claim 1, wherein the external device is either a handsfree headset, charger, or data transmission device.

7. A device coupling to an external device comprising at least one first connecting port, one cable, and a main unit, wherein the cable coupled between the first connecting port and main body, comprising:
a second connecting port coupling to the first connecting port;
a detecting device detecting an impedance of the cable and outputting an electrical parameter when the first connecting port is connected to the second connecting port; and
a processing device determining the cable type and providing corresponding function to the main unit according to the electrical parameter.

8. The device as claimed in claim 7, wherein the detecting device comprises a resistor, the resistor connected in series with the cable to create a potential divider, and the electrical parameter is voltage output from the potential divider.

9. The device as claimed in claim 8, wherein when the second connecting port connects with the first connecting port, the second connecting port sends a signal to the processing device thereby the processing device receives the signal and judge accordingly the type of cable.

10. The device as claimed in claim 9, wherein the second connecting port receives or outputs a corresponding signal according to the corresponding function provided from the processing device.

11. The device as claimed in claim 7, wherein the external device is either a handsfree headset, charger, theft prevention device, or data transmission device.

12. The device as claimed in claim 7, wherein the first connecting port plugs into or contacts with the second connecting port.

13. A mobile apparatus having theft prevention function, the mobile apparatus comprising:
a first connecting port accepting an external device;
a detecting device coupled to the first connecting port, detecting an electrical parameter of the external device when the external device is connected to the first connecting port;
a processing device determining the external device type and providing corresponding function to the external device according to the electrical parameter; and
a theft prevention device comprising a second connecting port for connecting the first connecting port, wherein when the theft prevention device is coupled to the first connecting port, the processing device activates the theft prevention function, and the processing device generates alarm when the theft prevention device is unexpectedly disconnected from the first connecting port.

14. The mobile apparatus as claimed in claim 13, wherein the detecting device comprises a resistor, connected in series with the external device to create a potential divider, and the electrical parameter is detected via voltage output from the potential divider.

15. The mobile apparatus as claimed in claim 13, wherein the processing device receives a signal output from the connecting port and determines the external device type when the external device connects to the connecting port.

16. The mobile apparatus as claimed in claim 15, wherein the first connecting port receives or outputs a corresponding signal according to the corresponding function provided from the processing device.

17. The mobile apparatus as claimed in claim 13, wherein the external device is a handsfree headset, charge device, or data transmission device.

18. The mobile apparatus as claimed in claim 13, wherein the second connecting port plugs into the external device or the theft prevention device.

19. The mobile apparatus as claimed in claim 13, wherein the external device or the theft prevention device contacts with the first connecting port.
